(19) United States
(12) Patent Application Publication
(10) Pub. No.: US 2013/0337107 A1
(43) Pub. Date: Dec. 19, 2013

(54) CHEWING GUM ALTERNATIVE BULKING AGENTS

(71) Applicants: John Hammond, Crete, IL (US); David G. Barkalow, Deerfield, IL (US); Gwendolyn Graff, DeKalb, IL (US); Joseph Bell, Lombard, IL (US); Chia-Hua Hsu, Glenview, IL (US)

(72) Inventors: John Hammond, Crete, IL (US); David G. Barkalow, Deerfield, IL (US); Gwendolyn Graff, DeKalb, IL (US); Joseph Bell, Lombard, IL (US); Chia-Hua Hsu, Glenview, IL (US)

(73) Assignee: WM. WRIGLEY JR. COMPANY, Chicago, IL (US)

(21) Appl. No.: 14/002,800

(22) PCT Filed: Mar. 2, 2012
(86) PCT No.: PCT/US12/27467

§ 371 Date: Sep. 3, 2013

Related U.S. Application Data
(60) Provisional application No. 61/449,168, filed on Mar. 4, 2011.

(51) Int. Cl. A23G 4/10

(52) U.S. Cl. CPC A23G 4/10
USPC 426/3

(57) ABSTRACT

A chewing gum composition containing at least 25 wt. % water-soluble portion containing a least one simple sugar and at least one water-soluble fiber; and at least 25 wt. % water-insoluble portion containing at least 10 wt. % chewing gum base filler and at least 10 wt. % chewing gum non-filler base composition. Such a combination of water-soluble and water-insoluble materials produces a healthy amount of fiber, while creating a chewing gum with an acceptable mass duration, elasticity, cohesion, flavor delivery, and sweetness delivery.

### CROSS-REFERENCE TO RELATED APPLICATIONS

This application supplements U.S. Provisional Application No. 61/449,168, filed Mar. 4, 2011, incorporated by reference herein.

### BACKGROUND OF THE INVENTION

The present invention relates to an improved chewing gum composition and, more specifically, relates to an improved chewing gum composition using bulking agents to give acceptable texture and flavor, while increasing the healthiness of the chewing gum.

Chewing gum comprises a water-soluble portion and a water-insoluble portion. Typically the water-soluble portion is comprised of water-soluble bulking agent, such as sucrose, and other water-soluble components, such as flavors, sensates, colors, and high intensity sweeteners. Typically the water-insoluble portion is comprised of chewing gum base, which contains a water-insoluble chewing gum non-filler base and a water-insoluble chewing gum base filler. Whereas the water-soluble portion slowly dissolves during chewing and is swallowed, the water-insoluble portion does not dissolve during chewing and is removed from the mouth when mastication is complete.

Traditionally, sucrose was used as the water-soluble bulking agent for chewing gums. Sucrose gives volume to a chewing gum mass and slowly dissolves during chewing, which slowly releases sweetness and enhances flavor delivery of the chewing gum. Sucrose has a pleasant flavor, is very soluble, but sucrose has some health related limitations.

In recent years, efforts have been made to improve the healthiness of chewing gum products by making the products non-carriogenic and safe for diabetics by replacing the water-soluble bulking agent with ingredients other than sucrose. Dental caries is an infectious disease which damages the structure of teeth. Tooth decay, or cavities, are the consequences of caries. To not create dental caries is to be non-carriogenic. Non-carriogenicity or “toothfriendliness” of a substance such as a saccharide or a saccharide derivative may be determined by means of intraoral pH telemetry such as used by Toothfriendly International, a non-profit organization. In a standard procedure, plaque pH is measured in at least four persons during and for 30 minutes after consumption of a substance to be tested with a plaque-covered electrode. Products which do not lower plaque pH below 5.7, under the test conditions, are considered to lack carriogenic potential. A preferred chewing gum is non-carriogenic.

In sucrose-free chewing gums, sucrose typically is replaced with polyols, such as sorbitol, maltitol, isomalt, mannitol, xylitol, and erythritol, which are non-carriogenic. Sorbitol is used commonly due to availability and cost, while maltitol is used due to similarity to sucrose in sweetness and solubility.

A disadvantage of most polyols is causation of gastrointestinal disturbances (such as “laxation”) upon consumption. Typically, a material is considered not to cause gasto-intestinal disturbances (e.g., non-laxative), if such material is either substantially absorbed before entering the large intestine or passes though the large intestine substantially unchanged, in the quantities present in chewing gum. The amount of gastrointestinal disturbance or laxation distress experienced by a consumer of a chewing gum typically depends on the sensitivity of the consumer, the specific polyol used in the gum, and the amount of gum chewed. Erythritol is a polyol that does not cause gastro-intestinal disturbances, but is too expensive for most commercial gum uses.

Further, today consumers desire healthy snacks and food products. One ingredient that has been gaining popularity is dietary fiber, sometimes called roughage. Fiber is the indigestible portion of plant foods having two main components: water-soluble fiber and water-insoluble fiber. Both move through the digestive system, absorbing water and making defecation easier. Water-soluble fiber typically contains polysaccharides of varying size including plant components such as dextrin, inulin, and oligosaccharide. Water-soluble fiber are polysaccharides typically having average molecular weights from about 500 and to about 8000, corresponding to 3 to 60 saccharide units.

The term water-insoluble fiber typically refers to polysaccharides of varying size, but which are indigestible and are water-insoluble. Water-insoluble fiber often has average molecular weights greater than 8000, corresponding to greater than 60 saccharide units, though polysaccharides of cellulose can be water-insoluble at lower molecular weights. Both starch and non-starch based polysaccharides of various lengths can be heat, enzyme, or chemically treated to make the resulting polysaccharide more or less water-soluble.

The American Dietetic Association recommends consumption of a minimum of 20 to 35 grams per day of dietary fiber for a healthy adult. Regulatory agencies such as the U.S. Food and Drug Administration have given approvals for food products making health claims for fiber, based on recognition of the growing scientific evidence for physiological benefits of increased fiber intake. Both water-soluble and water-insoluble fiber has the added advantage over simple sugars of being non-carriogenic as it is not digested by enzymes in the mouth into simple sugars.

However, water-soluble fibers typically create a slimy, slippery textured fluid in the mouth when combined with saliva during mastication. Thus, a water-soluble bulking agent useful for a chewing gum composed of water-soluble fiber alone as a replacement for sucrose is not suitable for normal consumer use. Also, water-insoluble fiber can create a “chalky” or gritty texture in the mouth as chewing gum containing them is masticated, as some of the insoluble materials break into smaller pieces and are suspended in saliva. Therefore, a preferable chewing gum containing water-soluble and/or water-insoluble fiber also has an acceptable mouthfeel including a non-slimy and non-chalky sensation during consumption.

Water-soluble fiber materials that have been used to replace sucrose in sucrose-free chewing gums include refined polydextrose, indigestible dextrin, inulin, and/or fructooligosaccharide. These dietary fibers are water-soluble and dissolve in saliva as the chewing gum is masticated. A reduction in the tendency for slimy mouthfeel (i.e., texture in mouth) can be accomplished by combining the water-soluble fiber with a crystalline, low water solubility, 4-7 carbon sugar or polyols, such as erythritol, isomaltulose, and tagatose. These combined water-soluble fiber and crystalline materials can make a commercially acceptable chewing gum, though cost can be prohibitive for many consumers.

Therefore, there is a need for an acceptable water-soluble bulking agent for use in chewing gum that will deliver the properties of sucrose in chewing gum, but be less carriogenic and deliver commercially acceptable mouthfeel, flavor and sweetness. Preferably, the water-soluble bulking agent is less expensive to use than sucrose. Preferably, the alternative water-soluble bulking agent contains water-soluble fiber.

Consumers buy chewing gum for the pleasure of the physical act of chewing and for the delivery of sweetness and flavor during that chewing experience. Consumers require a certain amount of mass to remain in the mouth during mastication of chewing gum to realize that pleasure of chewing. The mass must be at least in part elastic, that is, it must deform and reform with resistance during mastication. To have that elastic character, the mass must have the ability to be cohesive, that is to remain in mostly a single mass under the mechanical exertion of mastication. Typically, consumers want at least 0.6 g mass, but not more than 4.0 g mass in their mouth while masticating chewing gum. Less mass, and the consumer will not perceive the elastic character of the chewing gum. Water soluble bulking agent may be added to the chewing gum base to create a starting chewing mass weight, but they dissolve and leave behind the water-insoluble portion of the chewing gum, which is eventually removed from the mouth and thrown away.

Consumers often masticate chewing gum from 5 to 20 minutes, and up to 2 hours in some markets. Traditionally chewing gum contains chewing gum base that provides the material that will remain in the mouth throughout mastication giving mass duration while still being cohesive and elastic in texture.

Traditional chewing gum base is comprised of several materials, including food-compatible elastomers, resins, fats and oils, waxes, softeners and gum base fillers. Gum base fillers have been used to reduce the amount of food-compatible elastomers, resins, fats and oils, waxes, softeners used in a chewing gum, as gum base filler materials are less expensive. Typical gum base fillers are inorganic materials, such as calcium carbonate, magnesium carbonate, talc, or declaim phosphate, that are added to the chewing gum to replace part of the mass of the chewing gum base. These gum base fillers are not elastic, nor create cohesiveness. Too much gum base filler could interfere with the elastomer and reduce chewing gum elasticity and cohesiveness. As the chewing gum is masticated, these gum base fillers are water insoluble and, for the most part, remain trapped with the rest of the water-insoluble chewing gum materials until the remaining mass is removed from the mouth.

Efforts have been made to improve the healthiness of chewing gum products by replacing at least a portion of the chewing gum base with a material of nutritive value. The challenge has been providing alternative chewing gum base materials that will deliver the required finished chewing gum properties of mass duration, cohesiveness and elasticity during mastication. Proteins, such as gluten, have been added to chewing gum as full or partial replacement for the chewing gum non-filler base materials. Proteins can provide some cohesiveness and elastic texture initially, but proteins breakdown during mastication, mix with saliva, and are swallowed early in the chewing experience and do not create mass duration. These properties can limit the ability of proteins to provide elasticity and cohesion throughout the chewing experience.

Therefore there is a need for an alternative water-insoluble chewing gum base filler material to be used as a full or partial replacement of traditional chewing gum base ingredients of food-compatible elastomers, resins, fats and oils, waxes, softeners, and inorganic fillers, while delivering chewing gum with commercially acceptable elasticity and cohesion and additionally being more nutritive than traditional chewing gum. Lower cost would be an added benefit.

### SUMMARY OF THE INVENTION

A chewing gum composition containing at least 25 wt. % water-soluble portion containing a least one simple sugar and at least one water-soluble fiber; and at least 25 wt. % water-insoluble portion containing at least 10 wt. % chewing gum bas filler and at least 10 wt. % chewing gum non-filler base composition. Such a combination of water-soluble and water-insoluble materials produces a healthy amount of fiber, while creating a chewing gum with an acceptable mass duration, elasticity, cohesion, flavor delivery, and sweetness delivery.

### DETAILED DESCRIPTION OF THE INVENTION

In embodiments of this invention, certain bulking agents are incorporated into chewing gum such that the final chewing gum product has commercially acceptable mass duration, chewing texture (including cohesiveness and elasticity), and mouthfeel, along with a acceptable flavor and sweetness delivery. In further embodiments of this invention, the bulking agents have the additional benefits of being less carriogenic than sucrose, and/or containing fiber. More specifically, embodiments of this invention relate to improved formulations for chewing gum.

As used herein, the term “chewing gum” also includes bubble gum and confectionery products containing chewing gum. Unless otherwise specified, all percentages used herein are weight percents. As used herein, chewing gum base contains a gum non-filler base portion and a gum base filler portion.

A chewing gum composition typically contains a water-soluble portion and a water-insoluble portion. The water-soluble portion comprises water-soluble bulking agent and other water-soluble materials, such as flavors, colors, sensates and high intensity sweeteners. The water-soluble portion dissolves in saliva as the chewing gum is masticated, carrying in the resulting syrup the water-soluble flavor and sweetness during mastication. The water-insoluble portion of chewing gum remains in the mouth during the mastication experience and gives the chewing gum mass duration, cohesiveness, and elasticity without objectionable mouth feel. Traditionally, chewing gum base, including food-compatible elastomers, resins, fats and oils, waxes, softeners and gum base fillers provides these characteristics.

In embodiments of this invention conventional chewing gum water-soluble bulking agent and/or water-insoluble gum base filler are replaced by a combination of water-soluble and/or water-insoluble materials such that the finished chewing gum product is less carriogenic than traditional chewing gum containing sucrose as the only water-soluble agent, and yet has commercially acceptable mass duration, cohesiveness, elasticity, mouthfeel, and flavor and sweetness delivery during the mastication.

Typical chewing gum composition contains at least 5 wt. % of a water-soluble bulking agent. Further, typical chewing gum composition contains up to 95 wt. % of a water-soluble bulking agent. Typical ranges of water-soluble bulking agent in a chewing gum include 15 to 95 wt. %, preferably 65 to 75 wt. %. The traditional function of the water-soluble bulking agent is to provide volume to the gum mass and to act to transport at an acceptable rate water-soluble flavors and sweeteners within a person's mouth throughout the chewing process. Conventional water-soluble bulking agents, such as sucrose, have usually been dissolved and swallowed within the first 3-12 minutes of chewing. Most of the remaining mass comprises water-insoluble materials.

In an embodiment of the invention, the water-soluble bulking agent may constitute between 15 wt. % to about 99% of the water soluble portion of the chewing gum. Preferably, the water-soluble bulking agent comprises about 90-99% of the water-soluble portion of the chewing gum.

Sucrose is the most commonly used water-soluble bulking agent in chewing gum. Sucrose gives a clean, sweet flavor, is relatively inexpensive, and provides a syrup in the mouth to carry sweetness and flavor during mastication. The water-soluble portion of a chewing gum typically also includes other water-soluble materials, such as high intensity sweeteners, flavors and sensates. Flavoring agents can include flavor intensifying agents, and flavor masking agents. Flavoring agents can be natural or artificial, and can be neat or encapsulated.

Ingestion of sucrose can cause an increase in blood glucose levels. In the growing interest by consumers in healthy snacks and confections, several alternative materials have been explored as replacements for sucrose that would cause less increase in blood glucose levels. Sucrose can be replaced by fructose as a more healthy water-soluble bulking agent, as fructose causes less increase in blood glucose levels than sucrose making it healthier for diabetics. However, fructose is still carriogenic.

Polyols have been used to replace sucrose as the water-soluble bulking agent in chewing gum. Polyols are water-soluble, non-carriogenic and safe for diabetics, but most polyols can cause gastro-intestinal disturbances.

In general, a saccharide is a carbohydrate described as a simple sugar, a combination of sugars, or polymerized sugars. Simple sugars typically contain four to seven carbon atoms with a formula CₙH₂ₙOₙ. Examples of simple sugars include glucose, fructose, lactose, ribose, xylose, mannose, arabinose, and galactose and typically are characterized as aldehydes or ketones (aldose or ketoses), which exist in linear or cyclic hemi-acetal or ketal configurations. Combinations of mono-saccharides or simple sugars form di-saccharides (such as sucrose) and polysaccharides (such as starches and cellulose). Hydrogenated derivatives of mono-saccharides include sugar alcohols such as sorbitol, mannitol, and xylitol. A disaccharide contains two saccharide units and a polysaccharide contains more than two saccharide units.

A water-soluble bulking agent material useful in embodiments of this invention is one or more water-soluble polysaccharide compositions recognized as water-soluble fiber. These polysaccharides are characterized as typically containing at least three, preferably up to sixty, polysaccharide units. These could be polysaccharides of starch or cellulose that have been heat, chemical, and/or enzyme treated to make them water-soluble. Additionally, water-soluble fiber does not contribute to dental caries (i.e. non-carriogenic) because such dietary fibers are not metabolized by bacteria in the mouth. Further, such dietary fiber does not cause gastrointestinal disturbances in the amounts used in chewing gum. Finally, dietary fiber is low in calories due to its limited digestibility. Non-limiting, but preferred, examples of such dietary fiber useful in embodiments of this invention include inulin, fructooligosaccharide, and indigestible dextrin.

A water-soluble bulking agent component useful in embodiments of this invention is one or more water-soluble food hydrocolloids. A food hydrocolloid is a water-soluble, nonstarch, noncellulose polysaccharide, which have the ability to create gel structures in aqueous environments. A non-limiting list of hydrocolloid materials include pectin, carrageenan gum, locust bean gum, xanthan gum, agar, gum acacia, chitosan, and various combinations thereof. Hydrocolloids, in native or hydrolyzed form, are water soluble and can give volume and elasticity to a chewing gum mass, while being water soluble and providing the required syrup in the mouth during mastication. Physical form and addition of additional materials to the chewing gum, such as calcium or food grade acid, will affect the solubility of the hydrocolloids added to the chewing gum. The less water-soluble the hydrocolloid, the longer it will stay in the mouth and add to the cohesiveness and elasticity of the full chewing gum mass.

In an embodiment of this invention, a chewing gum composition comprises a water-soluble portion, containing a water-soluble bulking agent; and a water-insoluble portion, containing a water-insoluble chewing gum non-filler base composition and a water-insoluble chewing gum filler base containing water-insoluble fiber, wherein the water-insoluble chewing gum filler base contains polysaccharide and the water-soluble chewing gum non-filler base composition contains food-compatible elastomers, resins, fats and oils, waxes, and softeners. In an embodiment of this invention, a chewing gum composition comprises at least 15 wt. % water-soluble fiber; at least 15 wt. % of a water-insoluble fiber; and at least 15 wt. % chewing gum non-filler base composition. In an embodiment of this invention, a chewing gum comprises of a bulking agent and a chewing gum non-filler base composition, wherein the bulking agent contains a water-soluble fiber, and a water-insoluble fiber, and a simple sugar.

In an embodiment of this invention, a chewing gum composition contains at least 15 wt %, at least 30 wt. %, or at least 75 wt. % water soluble portion. In an embodiment of this invention, the water-soluble portion contains at least 65 wt. %, 75 wt %., or 99 wt % water-soluble bulking agent. The function of the water soluble portion is to give volume to the chewing gum composition and to create a syrup in the mouth for carrying flavors and sweetness during mastication. In an embodiment of this invention, the water-soluble bulking agent includes a combination of mono- and/or di-saccharides, and a combination of longer polysaccharides (preferably, 3 to 60 saccharide units), such that the combination will create a commercially acceptable, non-slimy mouth feel syrup in the mouth as the chewing gum is masticated. In a further embodiment of this invention, the water-soluble bulking agent a also includes hydrocolloids, either in native or hydrolyzed form.

In another embodiment of this invention, a chewing gum composition contains at least 5 wt. %, 25 wt %., or 95 wt % water-soluble bulking agent. In this embodiment of this invention, the water-soluble bulking agent includes a combination of mono- and/or di-saccharides and a combination of longer polysaccharides (preferably, 3 to 60 saccharide units), such that the combination will create a commercially acceptable, non-slimy mouth feel syrup in the mouth as the chewing gum is masticated. In a further embodiment of this invention, the water-soluble bulking agent includes hydrocolloids.

Typically chewing gum compositions contain at least 5 wt. % water-insoluble portion. Typical ranges of water-insoluble portion in chewing gum include 15 to 96 wt. %, preferably 15 to 75 wt. %. The typical chewing gum water-insoluble portion ranges from 15 to 99 wt. %. Optionally, the chewing gum water-insoluble portion also includes chewing gum base filler in a range of 5 to 35 wt. % of the water-insoluble portion. Some of the gum base filler may remain embedded in the chewing gum base mass composition throughout mastication and then be removed from the mouth at the end. The function of the gum base filler is to provide mass, not elasticity or cohesion. The function of the water-insoluble chewing gum non-filler base composition is two fold: 1) to provide volume to the gum mass during mastication until it is removed from the mouth; and 2) to give elasticity and cohesion to the chewing gum during mastication.

Typical water-insoluble chewing gum base composition contains food-compatible elastomers, resins, fats and oils, waxes, softeners, chewing gum base filler and combinations thereof. Elastomers may include polyisobutylene, isobutylene-isoprene copolymer (butyl rubber) and styrene butadiene rubber, as well as natural latexes such as chicle. Resins include polyvinylacetate and terpene resins. Fats and oils also may be included in the gum base, including tallow, hydrogenated and partially hydrogenated vegetable oils, and cocoa butter. Commonly employed waxes include paraffin, beeswax, and carnauba. According to an embodiment of the present, the water-insoluble gum base constitutes 15-96 wt. of the gum, preferably 15 to 75 wt. % of the gum.

Softeners are added to the chewing gum in order to optimize the chewability and texture of the gum. Softeners, also known in the art as plasticizers or plasticizing agents, generally constitute up to about 15 wt. % of the chewing gum base. Examples of softeners include glycerin, lecithin and combinations thereof.

Chewing gum also may contain other softeners, including glycerol monostearate and glycerol triacetate. Further, chewing gum may also contain optional ingredients such as antioxidants, colors, and emulsifiers. A chewing gum of embodiments of the present invention typically may include any commercially-acceptable water-insoluble gum non-filler base composition.

Typical chewing gum base fillers include inorganic materials, such as calcium carbonate, magnesium carbonate, talc, dicalcium phosphate, or the like. These inorganic gum base fillers typically constitute between about up to 60 wt. %, preferably about 5 wt. % to about 50 wt. %, of the chewing gum. Chewing gum base fillers combine with the water-insoluble chewing gum base materials and remain, for the most part, in the mouth throughout the mastication. The purpose of the inorganic filler is to give mass to the chewing gum.

Traditional chewing gum base, which includes chewing gum base fillers, have little or no nutritional value. With the growing trend in consumers wanting healthy snacks and confections, there is a need for a more nutritionally valued water-insoluble chewing gum portion. The water-insoluble portion must not interfere with the commercial acceptability of the chewing gum elasticity and cohesion during mastication.

In an embodiment of this invention, the water-insoluble chewing gum portion of the chewing gum contains a combination of water-insoluble materials that will remain in the mouth during all or most of mastication and will not create a commercially unacceptable elasticity or cohesion during mastication. In a further embodiment of this invention, the water-insoluble chewing gum portion contains a water-insoluble gum base filler, other than an inorganic material such as calcium carbonate, magnesium carbonate, talc, dicalcium phosphate.

In an embodiment of this invention, the water-insoluble chewing gum portion of this embodiments of this invention contain a water-insoluble chewing gum non-filler base composition and a water-insoluble gum base filler, which contains a water-insoluble fiber. The water-insoluble chewing gum base composition contains a gum non-filler base composition, comprising of several materials, including food-compatible elastomers, resins, fats and oils, waxes, softeners, and combinations thereof. The water-insoluble fiber is polysaccharide of starch and/or cellulose having an average unit length corresponding of at least 3, preferably greater than 60 saccharide units. Polysaccharides can be treated by heat, chemical, or enzyme treatment to make them water-insoluble.

Additionally, water-insoluble fiber does not contribute to dental caries (i.e. non-carriogenic) because such fibers are not metabolized by bacteria in the mouth. Further, such fiber does not cause gastrointestinal disturbances in the amounts used in chewing gum. Finally, fiber is low in calories due to its limited digestibility. In a further embodiment of this invention, the water-insoluble bulking agent is sourced from plant materials, such as sugar cane, sugar beet, coconut, fruit, vegetable, grain, or bean. The water-insoluble bulking agent could be from various parts of a plant including fruit, seed, shell, stem, stalk, root, bark, or combinations thereof.

Plant materials contain various polysaccharides (such as, simple sugars, starch, cellulose, and combinations thereof) in various amounts depending on the plant source (such as sugar cane, sugar beet, coconut, fruit, vegetable, grain, or bean), part of plant (such as fruit, seed, shell, stem, stalk, root, or bark), and amount of processing (such as heating, grinding, extracting, or treating chemicals or enzymes). Many plants, such as sugar cane, sugar beets, coconut, fruit, vegetable, grain, and beans, are processed by manufactures in order to extract sugars, starch, hydrocolloids, or flavors. After processing, the plant matter remains that mostly contains water-insoluble polysaccharide material. As such remaining plant matter is a byproduct of the primary production, these water-insoluble materials are often considered waste, or are used as part of animal feed. These plant materials may also contain residual water-soluble hydrocolloid materials, such as, but not limited to pectin, carrageenan gum, locust bean gum, xanthan gum, agar, gum acacia, chitosan, and combinations thereof.

In an embodiment of this invention, such plant byproduct material can be suitably ground and mixed with other chewing gum materials (such as chewing gum non-filler base composition and water-soluble bulking agent in such a way as to provide a chewing gum product with commercially acceptable mass duration, elasticity and cohesiveness during mastication. Preferably, this plant material would replace part of the water-insoluble chewing gum base composition of chewing gum, creating a less expensive final chewing gum product. As the plant material is fiber, it has a greater nutritional value than that of the chewing gum base material it replaces.

Chewing the plant byproduct insoluble material would be similar to chewing the soft base of a blade of grass, straw, sun flower seed shells, pumpkin seed shells, or orange rind. Mastication eventually breaks some of the cellulose and starch based polysaccharide matter into small enough pieces to be mixed with saliva and swallowed, but most of the matter remains in the mouth during chewing. Plant matter would have a range of inherent elasticity depending on its source and related content. Fruit byproduct plant matter could contain some form of gellable pectin or other hydrocolloid, whereas, wheat grain plant matter could contain a form of inflexible bran. The same is true of materials with sticky, or emulsifying properties, which would effect the final chewing gum product cohesiveness.

In an embodiment of this invention, the plant matter chosen to be used as the water-insoluble gum base filler in chewing gum would contain at least 20 to 90 wt. % cellulose or starch based polysaccharide. Preferably, the plant matter would contain at least 20 to 90 wt. % cellulose or starch based polysaccharide and 5 to 20 wt. % hydrocolloid.

The water-insoluble gum base filler would be included in the chewing gum product of some embodiments of this invention for the purpose of providing mass to the chewing gum and providing a water-insoluble material to chew throughout all or most of the mastication experience.

The physical properties of the water-insoluble gum base filler material can be adjusted (such as by particle size and structural fragility) so that most, or only a small portion, of the water-insoluble gum base filler would physically break down into smaller particles during mastication. This mass duration effects the ability of the finished chewing gum to meet consumer chewing satisfaction needs. Thus, the amount of breakdown could be adjusted so as to meet commercial acceptance towards mass duration, elasticity, and cohesion during mastication. Preferably, at least 50 wt. % of the plant matter added to a chewing composition of embodiments of this invention as the water-insoluble gum base filler would remain in the mouth until it was removed from the mouth for disposal.

In an embodiment of this invention conventional chewing gum water-soluble and/or water-insoluble materials are replaced by a combination of materials, such that the combination creates a syrup in the mouth with a pleasant mouthfeel, sweetness, and flavor delivery, while also creating a mass that is cohesive and elastic throughout the chewing experience.

The water-insoluble forms of fiber, such as polysaccharides of longer length, may be used as a water-insoluble gum base filler in chewing gum because it is insoluble, resistant to breakdown and can combine with other water-insoluble materials to make a cohesive and elastic mass the lasts in the mouth for the duration of the chewing experience. The challenge of these materials is their limited cohesiveness and elasticity, though they may be able to combine with other water-insoluble materials, such as chewing gum non-filler base composition, such that a chewing gum with commercially acceptable mass duration, cohesion, and elasticity can be produced.

The improved chewing gum of some embodiments of this invention uses a combination of water-soluble simple sugar and water-soluble fiber materials as the water-soluble bulking agent. This water-soluble bulking agent may be used in a variety of chewing gums, including bubble gum and coated chewing gum products. In this combination, a group of mono- and di-saccharides are used in conjunction with a group of water-soluble fibers to form a bulking agent suitable for use in a chewing gum, which does not have the disadvantages of water-soluble fiber used as the only component of a bulking agent, such as producing a slimy mouthfeel. Preferably, the improved chewing gum of embodiments of this invention additionally comprises a water-insoluble fiber as a water-insoluble chewing gum base filler. The addition of water-soluble and water-insoluble fiber materials has the advantage of being higher in fiber and lower in carriogenicity than traditional chewing gum made with simple sugars and gum base with inorganic gum base fillers.

In another embodiment of this invention, each of the water-soluble bulking agents and water-insoluble chewing gum base filler materials can be described in terms of amounts of a chewing gum. Thus, each of such components, (i.e., water-soluble bulking agent and water-insoluble gum base filler) separately typically is at least 5 wt. %, at least 10 wt. %, at least 20 wt. %, or at least 25 wt. % of a chewing gum composition. Each of such components separately may be present up to 70 wt. %, up to 60 wt %, up to 40 wt. %, or up to 30 wt. % of a chewing gum. Typical ranges of each such component separately include 5 to 70 wt. %, 5 to 60 wt %, 10 to 50 wt. %, and 20 to 40 wt. %. A chewing gum of embodiments of this invention additionally includes chewing gum non-filler base composition at a level of at least 5 wt. %, at least 10 wt. %, at least 50 wt. %, or at least 75 wt % of a chewing gum composition.

In an embodiment of this invention, a chewing gum composition containing a water-soluble portion and a water-insoluble portion, of which the water-soluble portion contains at least one simple sugar and one polysaccharide material of three or greater saccharide units, and of which the water-insoluble portion contains chewing gum non-filler base composition and at least one water-insoluble polysaccharide material, provides a commercially acceptable mass duration, cohesion, and elasticity during mastication with commercially acceptable mouthfeel, sweetness delivery and flavor delivery.

In a further embodiment of this invention, the chewing gum composition containing at least 25 wt. % of a water-soluble fiber, at least 25 wt. % water-insoluble fiber, and at least 15 wt. % water-insoluble chewing gum non-filler base composition, provides a commercially acceptable mass duration, cohesion, and elasticity during mastication with commercially acceptable mouthfeel, sweetness delivery and flavor delivery. In a further embodiment of this invention, the chewing gum also contains 5 to 20 wt. % hydrocolloid selected from the group consisting of pectin, carrageenan gum, locust bean gum, xanthan gum, agar, gum acacia, and combinations thereof in native or hydrolyzed form.

In a further embodiment of this invention, a chewing gum composition contains at least 25 wt. % of a water-soluble fiber, at least 25 wt. % water-insoluble fiber, and at least 15 wt. % water-insoluble chewing gum non-filler base composition, when used in making chewing gum provides a commercially acceptable mass duration, cohesion, and elasticity during mastication with commercially acceptable mouthfeel, sweetness delivery and flavor delivery. In a further embodiment of this invention, the chewing gum also contains 5 to 20 wt. % hydrocolloid selected from the group consisting of pectin, carrageenan gum, locust bean gum, xanthan gum, agar, gum acacia, chitosan, and combinations thereof in native or hydrolyzed form.

Depending on the particular saccharide materials chosen and the particular sweetness profile preferred, a combination of coated and uncoated high intensity sweeteners can be added. The sweetener amount may be present in the chewing gum in the amount within the range from about 0.01 wt. % to about 20.0 wt. %. A non-limiting listing of sweeteners contemplated by embodiments of the present invention includes saccharin, thaumatin, sucralose, alitame, saccharine salts, aspartame, acesulfame-K, Lo Han Guo, and rebinia.

A flavoring agent may be present in the chewing gum in an amount within the range of from about 0.1 wt. % to about 20 wt. %, and preferably from about 0.5 wt. % to about 5.0 wt. %, of the gum. The flavoring agents may comprise essential oils, synthetic flavors, or mixture thereof including, but not limited to, oils derived from plants and fruits such as citrus oils, fruit essences, peppermint oil, spearmint oil, clove oil, oil of wintergreen, anise, and the like. Artificial flavoring components are also contemplated for use in gums of embodiments of the present invention. Those skilled in the art will recognize that natural and artificial flavoring agents may be combined in any sensorially acceptable blend. All such flavors and flavor blends are contemplated by embodiments of the present invention.

Optional ingredients such as colors, emulsifiers, sensients, actives, medicants, and pharmaceutical agents, may be added to the chewing gum.

In general, chewing gum is manufactured by sequentially adding the various chewing gum materials to a commercially available mixer known in the art. After the ingredients have been thoroughly mixed, the gum mass is discharged from the mixer and shaped into the desired form such as by rolling into sheets and cutting into sticks, extruding into chunks or shapes, or casting into pellets, balls, or other shapes.

Generally, the water-insoluble materials are mixed by first melting the gum non-filler base materials and adding them to the preheated running mixer. The gum base filler materials may also be melted in the mixer itself. An amount of water-soluble bulking agent and other water-soluble materials may then be added to the mixer. After some agitation, the remaining water-soluble materials are added to the mixer, in portions or all at once. Any additional ingredients are typically added with the final portion of water-soluble bulking agent. Mixing occurs until degree of consistency is reached. Those skilled in the art will recognize that variations of the above procedure may be followed, for example, the mixer could be continuous and the components could be added in different orders. Also, some materials could be added as solutions or suspensions with water.

Examples of chewing gums with alternative ingredients.

The following examples illustrate, but do not limit this invention. The following ingredients illustrate how dextrose, cellulose, rice syrup and rice extract can be used as acceptable alternative ingredients to sucrose and corn syrup.

Example formulas of chewing gum formulations containing alternative bulking ingredients containing different forms of saccharide, cellulose, and/or fiber are shown in Tables 1-4. Each example used the same chewing gum process, with the addition of some mixing time as noted in the tables. Finished gum evaluation notes are also included in each table.

TABLE 1
Table 1: Chewing Gum Examples 1-6

| | 1 | | 2 | | 3 | | 4 | | 5 | | 6 | |
|---|---|---|---|---|---|---|---|---|---|---|---|---|
| | Description | | | | | | | | | | | |
| | | | Sugar + 20DE | | Sugar + 35DE | | | | Sugar + | | Sugar + | |
| | Dextrose + | | Rice Syrup | | Rice Syrup | | Sugar + Rice | | Solka | | Rice Flour | |
| | 42DE BRS | | Solid (50/50) | | Solid (50/50) | | Extract (50/50) | | Floc | | (75/25) | |
| Ingredients | wt % | Gram | wt % | Gram | wt % | Gram | wt % | Gram | wt % | Gram | wt % | Gram |
| Sugar-C | 0.00 | 0.00 | 33.31 | 26.65 | 33.31 | 26.65 | 32.57 | 26.06 | 55.14 | 44.11 | 48.86 | 39.08 |
| Dextrose | 65.09 | 52.07 | 0.00 | 0.00 | 0.00 | 0.00 | 0.00 | 0.00 | 0.00 | 0 | 0.00 | 0 |
| Rice | 0.00 | 0.00 | 0.00 | 0.00 | 0.00 | 0.00 | 32.57 | 26.06 | 0.00 | 0 | 0.00 | 0 |
| Extract | | | | | | | | | | | | |
| (Ribus) | | | | | | | | | | | | |
| Rice | 0.00 | 0.00 | 33.31 | 26.65 | 0.00 | 0.00 | 0.00 | 0.00 | 0.00 | 0 | 0.00 | 0 |
| Syrup | | | | | | | | | | | | |
| Extract | | | | | | | | | | | | |
| (20DE) | | | | | | | | | | | | |
| Rice | 0.00 | 0.00 | 0.00 | 0.00 | 33.31 | 26.65 | 0.00 | 0.00 | 0.00 | 0 | 0.00 | 0 |
| Syrup | | | | | | | | | | | | |
| Extract | | | | | | | | | | | | |
| (35DE) | | | | | | | | | | | | |
| Solka | 0.00 | 0.00 | 0.00 | 0.00 | 0.00 | 0.00 | 0.00 | 0.00 | 10.00 | 8 | 0.00 | 0 |
| Floc | | | | | | | | | | | | |
| Cellulose | | | | | | | | | | | | |
| Rice | 0.00 | 0.00 | 0.00 | 0.00 | 0.00 | 0.00 | 0.00 | 0.00 | 0.00 | 0 | 16.29 | 13.02 |
| Flour | | | | | | | | | | | | |
| Chewing | 19.80 | 15.84 | 19.80 | 15.84 | 19.80 | 15.84 | 19.80 | 15.84 | 19.80 | 15.84 | 19.80 | 15.84 |
| Gum | | | | | | | | | | | | |
| Base | | | | | | | | | | | | |
| Brown | 12.68 | 10.14 | 12.68 | 10.14 | 12.68 | 10.14 | 12.68 | 10.14 | 12.68 | 10.14 | 12.68 | 10.14 |
| Rice | | | | | | | | | | | | |
| Syrup | | | | | | | | | | | | |
| (42DE) | | | | | | | | | | | | |
| Glycerin | 1.48 | 1.18 | 0.00 | 0.00 | 0.00 | 0.00 | 1.48 | 1.18 | 1.48 | 1.18 | 1.48 | 1.18 |
| High | 0.05 | 0.04 | 0.00 | 0.00 | 0.00 | 0.00 | 0.00 | 0.00 | 0.00 | 0 | 0.00 | 0 |
| Intensity | | | | | | | | | | | | |
| Sweetener | | | | | | | | | | | | |
| Flavor | 0.90 | 0.72 | 0.90 | 0.72 | 0.90 | 0.72 | 0.90 | 0.72 | 0.90 | 0.72 | 0.90 | 0.72 |
| Total | 100.00 | 80 | 100.00 | 80.00 | 100.0 | 80.0 | 100.00 | 80.00 | 100.00 | 79.99 | 100.00 | 79.98 |

| | | | | | | |
|---|---|---|---|---|---|---|
| Processing | ok | ok | Not able to | Fluffy when | ok | ok |
| | | | sheet | mixing | | |
| Bench | Acceptable | Acceptable | Crumble | Astringent | Acceptable | Astringent |
| chew | texture | texture | texture | | texture | |
| | | | Feel crystals | | | mouthfeel |

TABLE 2
Table 2: Chewing Gum Examples 7-12

| | 7 | | 8 | | 9 | | 10 | | 11 | | 12 | |
|---|---|---|---|---|---|---|---|---|---|---|---|---|
| | Description | | | | | | | | | | | |
| | Sugar + | | Sugar + | | | | | | | | | |
| | 20DE | | 35DE | | Sugar + Rice | | Sugar + | | Dextrose + | | Dextrose + | |
| | Rice Syrup | | Rice Syrup | | Extract | | Solka | | Solka | | Corn Syrup | |
| | Solid (75/25) | | Solid (75/25) | | (75/25) | | Floc (10%) | | Floc (20%) | | (70/30) | |
| Ingredients | wt % | Gram | wt % | Gram | wt % | Gram | wt % | Gram | wt % | Gram | wt % | Gram |
| Sugar-C | 48.86 | 39.08 | 48.86 | 39.08 | 48.86 | 39.08 | 45.14 | 36.11 | 55.09 | 44.07 | 55.25 | 44.20 |
| Dextrose | 0.00 | 0.00 | 0.00 | 0.00 | 0.00 | 0.00 | 0 | 0.00 | 0.00 | 0.00 | 0.00 | 0.00 |
| Rice Extract | 0.00 | 0.00 | 0.00 | 0.00 | 16.29 | 13.03 | 0.00 | 0.00 | 0.00 | 0.00 | 0.00 | 0.00 |
| (Ribus) | | | | | | | | | | | | |
| Rice Syrup | 16.29 | 13.03 | 0.00 | 0.00 | 0.00 | 0.00 | 0.00 | 0.00 | 0.00 | 0.00 | 0.00 | 0.00 |
| Extract | | | | | | | | | | | | |
| (20DE) | | | | | | | | | | | | |
| Rice Syrup | 0.00 | 0.00 | 16.29 | 13.03 | 0.00 | 0.00 | 0.00 | 0.00 | 0.00 | 0.00 | 0.00 | 0.00 |
| Extract | | | | | | | | | | | | |
| (35DE) | | | | | | | | | | | | |
| Solka Floc | 0.00 | 0.00 | 0.00 | 0.00 | 0.00 | 0.00 | 20.00 | 16.00 | 10.00 | 8.00 | 0.00 | 0.00 |
| Cellulose | | | | | | | | | | | | |
| Chewing | 19.80 | 15.84 | 19.80 | 15.84 | 19.80 | 15.84 | 19.80 | 15.84 | 19.80 | 15.84 | 19.80 | 15.84 |
| Gum Base | | | | | | | | | | | | |
| Brwon Rice | 12.68 | 10.14 | 12.68 | 10.14 | 12.68 | 10.14 | 12.68 | 10.14 | 12.68 | 10.14 | 0.00 | 0.00 |
| Syrup | | | | | | | | | | | | |
| (42DE) | | | | | | | | | | | | |
| Corn Syrup | 0.00 | 0.00 | 0.00 | 0.00 | 0.00 | 0.00 | 0.00 | 0.00 | 0.00 | 0.00 | 23.33 | 18.66 |
| (45DE) | | | | | | | | | | | | |
| Glycerin | 1.48 | 1.18 | 1.48 | 1.18 | 1.48 | 1.18 | 1.48 | 1.18 | 1.48 | 1.18 | 1.48 | 1.18 |
| High | 0.00 | 0.00 | 0.00 | 0.00 | 0.00 | 0.00 | 0.00 | 0.00 | 0.05 | 0.04 | 0.05 | 0.04 |
| Intensity | | | | | | | | | | | | |
| Sweetener | | | | | | | | | | | | |
| Flavor | 0.90 | 0.72 | 0.90 | 0.72 | 0.90 | 0.72 | 0.90 | 0.72 | 0.90 | 0.72 | 0.09 | 0.07 |
| Total | 100.0 | 80.00 | 100.0 | 80.0 | 100.0 | 80.00 | 100.0 | 80.00 | 100.00 | 80.00 | 100.0 | 80.00 |

| | | | | | | |
|---|---|---|---|---|---|---|
| Processing | ok | ok, weak lands, | so-so mix, | Failed, didn't | Crumbly mix | ok, slight |
| | | might have | weak lands, | mix (increase | | tacky |
| | | problem when | crumbly | liquid might be | | |
| | | sheeting | | possible) | | |
| Bench chew | Acceptable | Acceptable | Crumble | Not so good | astringent | Acceptable |
| | texture | texture | texture | | | texture |

TABLE 3
Table 3: Chewing Gum Examples 13-18

| | 13 | | 14 | | 15 | | 16 | | 17 | | 18 | |
|---|---|---|---|---|---|---|---|---|---|---|---|---|
| | Description | | | | | | | | | | | |
| | | | Sugar + 20 DE | | Dextrose + | | | | Dextrose + | | Dextrose + 20 DE | |
| | | | Rice Syrup | | Solka | | | | Corn | | Rice Syrup | |
| | Dextrose | | Solid (75/25) | | Floc (10%) | | Black sugar | | Syrup (74/26) | | Solid (75/25) | |
| Ingredients | wt % | Gram | wt % | Gram | wt % | Gram | wt % | Gram | wt % | Gram | wt % | Gram |
| Sugar-C | 0.00 | 0.00 | 48.86 | 488.55 | 0.00 | 0.00 | 0.00 | 0.00 | 0.00 | 0.00 | 0.00 | 0.00 |
| Dextrose | 65.09 | 650.90 | 0.00 | 0.00 | 53.77 | 537.70 | 0.00 | 0.00 | 57.55 | 575.50 | 47.83 | 478.30 |
| Rice Syrup | 0.00 | 0.00 | 16.29 | 162.85 | 0.00 | 0.00 | 0.00 | 0.00 | 0.00 | 0.00 | 15.94 | 159.40 |
| Extract | | | | | | | | | | | | |
| (20DE) | | | | | | | | | | | | |
| Solka Floc | 0.00 | 0.00 | 0.00 | 0.00 | 10.00 | 100.00 | 0.00 | 0.00 | 0.00 | 0.00 | 0.00 | 0.00 |
| Cellulose | | | | | | | | | | | | |
| Black Sugar | 0.00 | 0.00 | 0.00 | 0.00 | 0.00 | 0.00 | 79.30 | 793.00 | 0.00 | 0.00 | 0.00 | 0.00 |
| Chewing | 19.80 | 198.00 | 19.80 | 198.00 | 19.80 | 198.00 | 19.80 | 198.00 | 19.80 | 198.00 | 19.80 | 198.00 |
| Gum Base | | | | | | | | | | | | |
| Brown Rice | 12.68 | 126.80 | 12.68 | 126.80 | 14.00 | 140.00 | 0.00 | 0.00 | 0.00 | 0.00 | 14.00 | 140.00 |
| Syrup (42DE) | | | | | | | | | | | | |
| Corn Syrup | 0.00 | 0.00 | 0.00 | 0.00 | 0.00 | 0.00 | 0.00 | 0.00 | 20.22 | 202.20 | 0.00 | 0.00 |
| (45DE) | | | | | | | | | | | | |
| Glycerin | 1.48 | 14.80 | 1.48 | 14.80 | 1.48 | 14.80 | 0.00 | 0.00 | 1.48 | 14.80 | 1.48 | 14.80 |
| High Intensity | 0.05 | 0.50 | 0.00 | 0.00 | 0.05 | 0.50 | 0.00 | 0.00 | 0.05 | 0.50 | 0.05 | 0.50 |
| Sweetener | | | | | | | | | | | | |
| Flavor | 0.90 | 9.00 | 0.90 | 9.00 | 0.90 | 9.00 | 0.90 | 9.00 | 0.90 | 9.00 | 0.90 | 9.00 |
| Total | 100.0 | 1000.0 | 100.0 | 1000. | 100.0 | 1000.0 | 100.0 | 1000.0 | 100.0 | 1000.0 | 100.0 | 1000.0 |

| | | | | | | |
|---|---|---|---|---|---|---|
| Processing | ok | ok | ok, need mixing | ok | ok | ok |
| | | | longer | | | |
| Bench chew | Acceptable | Acceptable | ok texture, | Good | Acceptable | Acceptable |
| | texture, Clean | texture, good | clean minty | sweetness | texture, clean | texture |
| | minty taste | sweetness | taste | profile | good tasting | |
| | | profile | | | profile | |

TABLE 4
Table 4: Chewing Gum Example 19

19
Description
Dextrose + Solka Floc (5%)

| Ingredients | % | Weight |
|---|---|---|
| Sugar-C | 0.00 | 0.00 |
| Dextrose | 58.77 | 587.70 |
| Rice Syrup Extract | 0.00 | 0.00 |
| (20DE) | | |
| Solka Floc Cellulose | 5.00 | 50.00 |
| Black Sugar | 0.00 | 0.00 |
| Chewing Gum Base | 19.80 | 198.00 |
| Brown Rice Syrup (42DE) | 1.00 | 140.00 |
| Corn Syrup (45DE) | 0.00 | 0.00 |
| Glycerin | 1.48 | 14.80 |
| High Intensity Sweetener | 0.05 | 0.50 |
| Flavor | 0.90 | 9.00 |
| Total | 100.00 | 1000.00 |
| Processing | Longer mixing | |
| | time | |

| | |
|---|---|
| Bench chew | Acceptable texture, |
| | tasting profile |

Chewing gums were prepared according to the formulas in Tables 1-4. Ingredients listed in the formulas were combined in a standard mixer preheated to 45 0 55 C. After thorough mixing, the gum was then sheeted, cut, and wrapped. Sensory bench chew evaluation was performed on the samples and results were recorded in Tables 1-4.

The ingredients in the formulas in Table 1-4 include: 1. Solka Floc (40 FCC): Purified cellulose fiber [Source: International Fiber Corporation, New York]; 2. Rice syrup extract (20 DE): Purified white, free-flowing powder with a particle size which passes through a standard 100 size mesh, with a 20 dextrose equivalent, clean and sweet flavor, produced by spray drying syrup which has been extracted from prime quality rice grains following a natural enzymatic treatment. [Source: AG Commodities Inc.]; 3. Rice syrup extract (35 DE): Rice syrup extract is a purified white, free-flowing powder with a particle size which passes through a standard 100 size mesh, with a target 35 dextrose equivalent, has a clean and sweet flavor, produced by spray drying syrup which has been extracted from prime quality rice grains following a natural enzymatic treatment. [Source: AG Commodities Inc.]; 4. Rice extract (Nu-Ribus): Rice extract is composed of functional components of the rice bran (lipids, proteins and complex carbohydrates), which provides binding of water and oil as well as extrusion characteristics. [Source: Ribus]; 5. Brown Rice Syrup (42 DE): Rice syrup product containing dextrose (19 wt. %), maltose (14 wt. %), trisaccharide (12 wt. %), and higher saccharides (56 wt. %). [Source; Malt Product Corporation]; and 6. Black sugar: sugar product similar to table dark brown sugar that contains molasses, and other minerals (e.g. potassium, iron, calcium, etc), though darker than table dark brown sugar black sugar.

As shown in Tables 1-4, different alternative ingredients created different finished chewing gum performance. Those noted as having “acceptable texture” had chewing texture similar to that of standard commercial sugar based chewing gum. Each example in the tables is an embodiment of this invention. Preferred embodiments are those that have “acceptable texture” noted in the tables. These preferred examples were able to create chewing gum textures under processing conditions similar to that of current commercial chewing gum formula, while containing less purified sugar based ingredients. Those examples in the tables noted as “astringent” or “crumbly” or “not so good” might become acceptable with adjustment of ingredients from that in the tables, such as with additional water. Because of such, they are also considered embodiments of this invention.

The compositions and methods of the present invention are capable of being incorporated in the form of a variety of embodiments, only a few of which have been illustrated and described above. The invention may be embodied in other forms without departing from its spirit or essential characteristics. The described embodiments are to be considered in all respects only as illustrative and not restrictive, and the scope of the invention, therefore, is indicated by the appended claims rather than by the foregoing description. All changes which come within the meaning and range of equivalency of the claims are to be embraced within their scope.

1-42. (canceled)

43. A chewing gum composition comprising:
a) at least 15 wt. % of a water-soluble fiber;
b) at least 15 wt. % of a water-insoluble fiber; and
c) at least 15 wt. % of a chewing gum non-filler base composition.

44. The chewing gum composition of claim 43 in which component a) is selected from the group consisting of inulin, fructooligosaccharide, indigestible dextrin or combination thereof.

45. The chewing gum composition of claim 43 containing at least 40 wt. % component a).

46. The chewing gum composition of claim 43 containing at least 40 wt. % component b).

47. The chewing gum composition of claim 43 containing at least 40 wt. % component c).

48. The chewing gum composition of claim 43 further comprising 5 to 20 wt. % hydrocolloid selected from the group consisting of pectin, carrageenan gum, locust bean gum, xanthan gum, agar, gum acacia, and combinations thereof.

49. The chewing gum composition of claim 43 further comprising 5 to 45 wt. % hydrolyzed starch, cellulose, hydrocolloid, or combinations thereof.

50. The chewing gum composition of claim 43 further comprising 5 to 60 wt. % inorganic filler selected from the group consisting of calcium carbonate, magnesium carbonate, talc, clay, dicalcium phosphate, or combinations thereof.

51. The chewing gum composition of claim 43 further comprising not more than 50 wt. % simple sugar.

52. A chewing gum composition comprising:
a) at least 25 wt. % of a water-soluble portion comprising:
at least one simple sugar and at least one water-soluble fiber; and
b) at least 25 wt. % of a water-insoluble portion comprising:
at least 10 wt. % chewing gum base filler and at least 10 wt. % chewing gum non-filler base composition.

53. The chewing gum composition of claim 52 in which water-soluble fiber component contains 3 to 60 saccharide units.

54. The chewing gum composition of claim 52 in which the water-soluble fiber is selected from the group consisting of inulin, fructooligosaccharide, indigestible dextrin or combination thereof.

55. The chewing gum composition of claim 52 in which the chewing gum base filler is a water-insoluble polysaccharide that contains greater than 3 saccharide units.

56. The chewing gum composition of claim 52 in which the water-insoluble polysaccharide is selected from the group consisting of polysaccharides of starch, cellulose, and combinations thereof.

57. The chewing gum composition of claim 52 comprising at least 40 wt. % component a).

58. The chewing gum composition of claim 52 further comprising 5 to 20 wt. % hydrocolloid selected from the group consisting of pectin, carrageenan gum, locust bean gum, xanthan gum, agar, gum acacia, and combinations thereof.

59. The chewing gum composition of claim 52 further comprising 5 to 45 wt. % hydrolyzed starch, cellulose, hydrocolloid, or combinations thereof.

60. The chewing gum composition of claim 52 further comprising 5 to 60 wt. % inorganic filler selected from the group consisting of calcium carbonate, magnesium carbonate, talc, clay, dicalcium phosphate, or combinations thereof.

61. The chewing gum composition of claim 52 further comprising not more than 50 wt. % simple sugar.

62. A bulking agent for use in chewing gum comprising:
a) at least 25 wt. % of a water-soluble fiber;
b) at least 25 wt. % of a water-insoluble fiber; and
c) at least 20 wt. % sugar selected from the group consisting of mono-saccharides, di-saccharides of combinations thereof.

63. The bulking agent composition of claim 62 in which component a) is selected from the group consisting of inulin, fructooligosaccharide, indigestible dextrin or combination thereof.

64. The bulking agent composition of claim 62 in which component b) contains 3 to 100 saccharide units.

65. The bulking agent composition of claim 62 in which component b) is selected from the group consisting of starch, cellulose, and combinations thereof.

66. The bulking agent composition of claim 62 containing at least 40 wt. % component a).

67. The bulking agent composition of claim 62 containing at least 40 wt. % component b).

68. The bulking agent composition of claim 62 containing at least 40 wt. % component c).

69. The bulking agent composition of claim 62 further comprising 5 to 20 wt. % hydrocolloid selected from the group consisting of pectin, carrageenan gum, locust bean gum, xanthan gum, agar, gum acacia, and combinations thereof.

70. The bulking agent composition of claim 62 further comprising 5 to 45 wt. % hydrolyzed starch, cellulose, hydrocolloid, or combinations thereof.

71. The bulking agent composition of claim 62 further comprising 5 to 60 wt. % inorganic filler selected from the group consisting of calcium carbonate, magnesium carbonate, talc, clay, dicalcium phosphate, or combinations thereof.

72. The chewing gum composition of claim 62 further comprising not more than 50 wt. % simple sugar.
